(19) United States
(12) Patent Application Publication
(10) Pub. No.: US 2006/0038063 A1
(43) Pub. Date: Feb. 23, 2006

(54) Shaped sonic boom aircraft

(75) Inventors: David Herbert Graham, San Pedro, CA (US); Domenic J. Maglieri, Williamsburg, VA (US); Hideo Ikawa, Huntington Beach, CA (US); Jay Lee Vadnais, Torrance, CA (US); Keith Brian Meredith, Carson, CA (US); Joseph William Pawlowski, Granada Hills, CA (US); John Albert Dahlin, Rancho Palos Verdes, CA (US); Marvin LeRoy Martin, Lancaster, CA (US)

Correspondence Address: Robert P. Lenart;Pietragallo, Bosick & Gordon, One Oxford Centre, 38th Floor, 301 Grant Street, Pittsburgh, PA, 15219, US

(73) Assignee: Northrop Grumman Corporation, Los Angeles, CA (US)

(21) Appl. No.: 10/920,616

(22) Filed: Aug. 18, 2004

(51) Int. Cl. B64C 30/00

(52) U.S. Cl. 244/35 A

(57) ABSTRACT

An aircraft comprises a fuselage, wings extending from the fuselage, and engine nacelles, wherein the fuselage has contours shaped to create shock and expansion zones to compensate for expansion zones and shocks produced by the wings and engine nacelles when the aircraft travels at supersonic speeds. The fuselage shape can be achieved by including a main fairing positioned along a bottom surface of the fuselage. The nacelles can be positioned adjacent to the fuselage and integral with the wings, and the aircraft can further include auxiliary fairings positioned along bottom surfaces of the nacelles.

### FIELD OF THE INVENTION

This invention relates to aircraft and more particularly to aircraft that produce a reduced intensity sonic boom when flying at supersonic speeds.

### BACKGROUND OF THE INVENTION

Any aircraft in flight produces changes in pressure in the medium in which it flies. These pressure changes or pressure waves propagate at the speed of sound for that medium and create regions around the aircraft that are above ambient pressure, as well as regions that are below ambient pressure. Typical aircraft components, such as the nose, inlet, canopy, fuselage, wing and tails, all produce changes in pressure. When an aircraft flies faster than the speed of sound for the surrounding medium, the aircraft is considered to be flying supersonic and the pressure waves cannot move fast enough to propagate forward of the aircraft. In supersonic flight, these pressures waves form into shock waves. Shock waves are characterized by abrupt increases in pressure and temperature over a short distance. For purposes of describing shock waves and sonic booms, near the aircraft is considered to be a distance within several fuselage lengths away from the aircraft, and a long distance is generally considered to be distance of more than 100 times the length of the aircraft. In the literature, the term “near field” is often used to describe near the aircraft and “far field” is used to designate a long distance from the aircraft. Near the aircraft, the individual shocks created by the aircraft components are often readily identifiable. At long distances from a conventional aircraft, these individual shocks coalesce into only two shocks, which are referred to as a nose or bow shock and a tail shock. If an individual shock wave is created in a region around the aircraft of ambient or above ambient pressure, the shock wave moves forward and contributes to the bow shock. If an individual shock wave is created in a region of pressure that is less than ambient, the shock tends to contribute to the tail shock. Between the nose shock and the tail shock, the pressure reduces gradually from the above ambient pressure of the nose shock to a pressure below ambient. The tail shock generally restores pressure to near-ambient levels. At long distances from the aircraft, only the nose shock, the tail shock and the region between the shocks remain identifiable. When these pressure changes are plotted in terms of time, the abrupt increase in pressure of the nose shock, followed by the more gradual pressure decrease between the shocks and the abrupt increase of the tail shock resembles the capital letter “N”. When such a shock wave propagates all the way to ground, it is classically referred to as an “N-wave” sonic boom. An aircraft can only create sonic booms when it exceeds the speed of sound in the medium in which it flies.

To a ground observer, an “N-wave” sonic boom may be perceived as one or two booms depending on the magnitude and duration of the shocks. Magnitude and duration of sonic booms are determined mainly by the size, weight and flight conditions of the aircraft that created them. Large, heavy aircraft will produce louder and longer duration booms than smaller aircraft. Other factors that determine the magnitude and duration are the aircraft flight path and the weather. Sonic booms are startling and may in some cases cause damage to property. Currently supersonic flight over the United States is generally prohibited except in specific areas controlled by the military.

It is unlikely that the regulations that prohibit supersonic flight over land will be changed unless aircraft can be produced that mitigate the sonic boom. Many approaches have been proposed that claim to reduce or entirely eliminate sonic boom. Generally these approaches fall into three categories that are discussed in the following paragraph: 1) the incorporation of passageways through the aircraft; 2) the incorporation of aircraft components to modify, deflect or cancel shocks, and 3) the incorporation of active systems to modify, deflect or cancel shocks.

Passageways through the aircraft are typically described in the literature as channels, ducts or conduits. Passageways on supersonic aircraft always incur penalties to the aircraft that result in increases in weight and complexity. Examples of additional components include new or auxiliary wings and lifting surfaces. The addition of aircraft components to modify, deflect or cancel shocks increases the weight and drag of an aircraft. Examples of active systems include movable spikes, variable nose bluntness and jets of high-pressure air. The addition of active systems to modify, deflect or cancel shocks increases the weight and complexity of an aircraft. Since aircraft weight is one of the primary contributors to the magnitude of a sonic boom, it is unlikely that most of the above approaches will result in a reduction of sonic boom.

Although some of the foregoing designs are directed to sonic boom mitigation, none of them address the sonic boom signature shaping techniques of the present invention.

It would be desirable to have an aircraft structure that does not include any new or auxiliary wings, airfoils, lifting surfaces or modifications to the wing surfaces for the purpose of reducing sonic booms.

It would also be desirable to have an aircraft structure that reduces the intensity of sonic booms caused by supersonic flight that is a passive structure, with no moving parts or spikes, channels, ducts or conduits for the purpose of reducing sonic booms.

### SUMMARY OF THE INVENTION

An aircraft comprises a fuselage, wings extending from the fuselage, and engine nacelles, wherein the fuselage has contours shaped to create shock and expansion zones to compensate for expansion zones and shocks produced by the wings and engine nacelles when the aircraft travels at supersonic speeds.

The fuselage shape can be achieved by including a main fairing positioned along a bottom surface of the fuselage. The nacelles can be positioned adjacent to the fuselage and integral with the wings, and the aircraft can further include auxiliary fairings positioned along bottom surfaces of the nacelles.

The main fairing can include a nose section, a center under fuselage section, and an aft section.

### BRIEF DESCRIPTION OF THE DRAWINGS

FIG. 1 is an upper perspective view of an aircraft constructed in accordance with this invention.

FIG. 2 is a top plan view of an aircraft constructed in accordance with this invention.

FIG. 3 is a left side view of an aircraft constructed in accordance with this invention.

FIG. 4 is a lower bottom view of an aircraft constructed in accordance with this invention.

FIG. 5 is a lower perspective view of an aircraft constructed in accordance with this invention.

FIG. 6 is a front view of an aircraft constructed in accordance with this invention.

FIG. 7 is a rear view of an aircraft constructed in accordance with this invention.

FIG. 8 is a left side view of an aircraft that has been modified in accordance with this invention.

FIGS. 9 through 15 illustrate the cross-sectional profile of the fuselage of the aircraft of FIG. 8 at several positions along the fuselage.

FIG. 16 is a graph of a baseline near field signature of an unmodified F-5E aircraft.

FIG. 17 is a graph of the near field signature of an aircraft constructed in accordance with the invention.

FIG. 18 is a graph showing sonic booms measured at ground level.

### DETAILED DESCRIPTION OF THE INVENTION

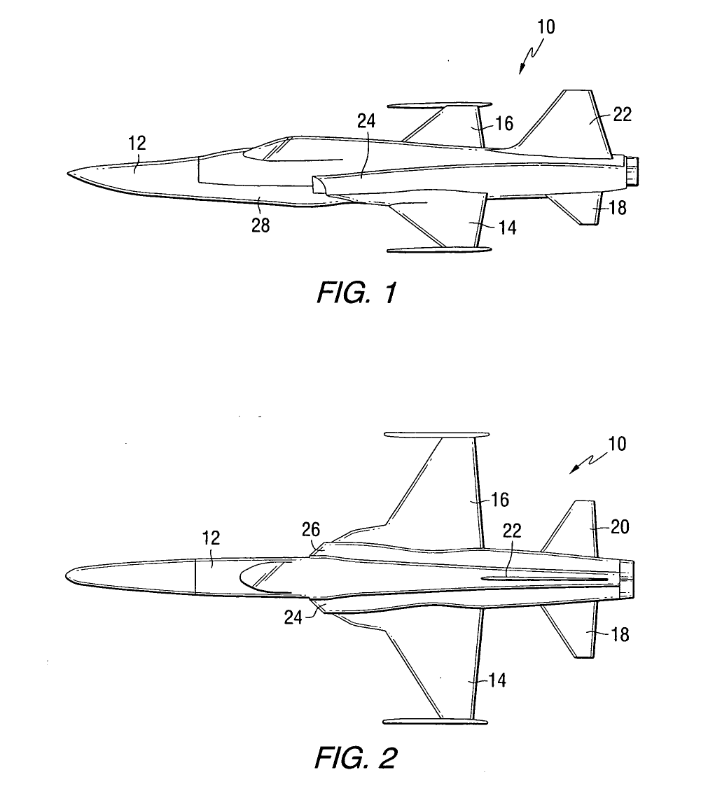

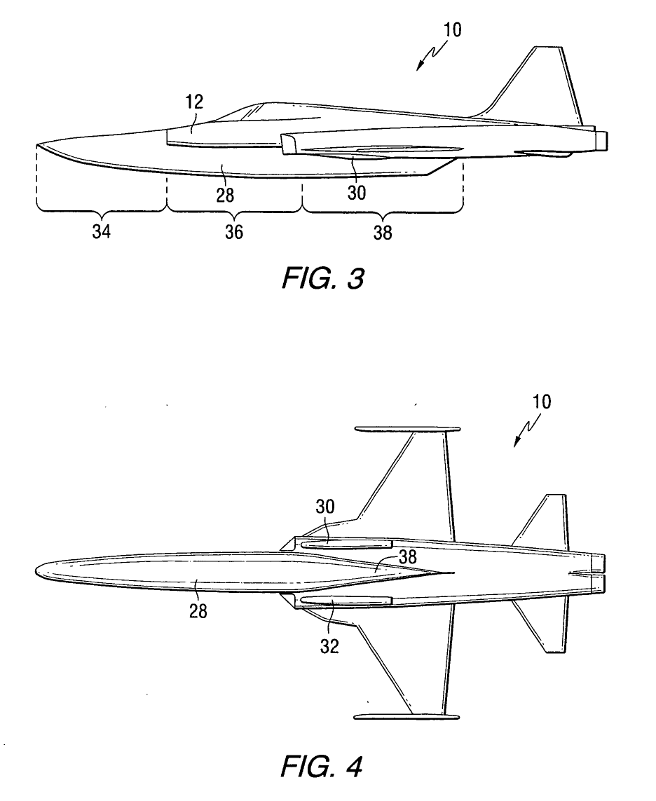

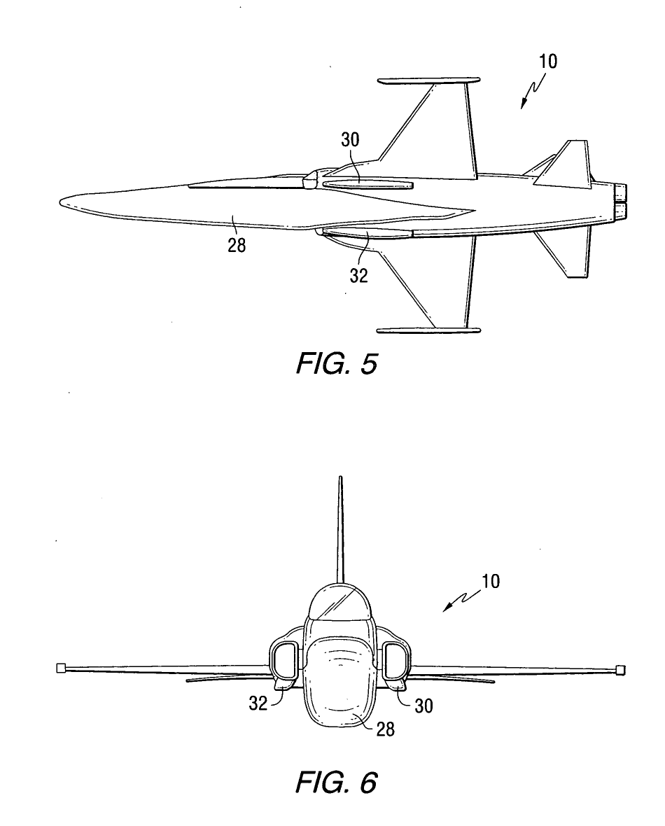

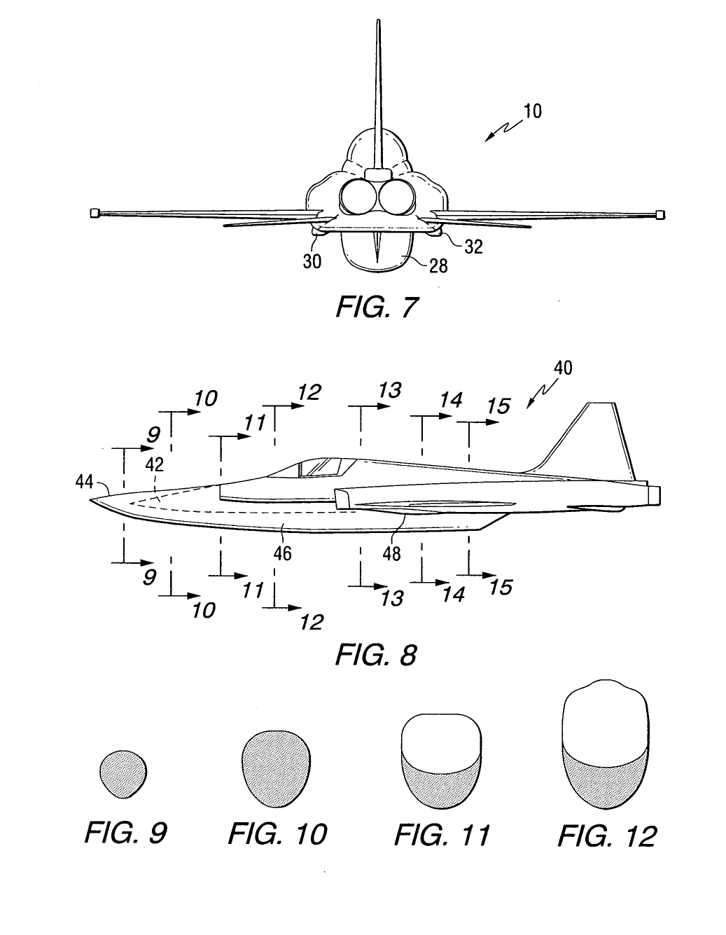

Referring to the drawings, FIGS. 1 through 7 are various views of an aircraft 10 constructed in accordance with this invention. The aircraft includes a fuselage 12, wings 14, 16, and a tail group 18, 20 and 22. Engine nacelles 24 and 26 are positioned adjacent to the fuselage and integral with the wings 14 and 16. To achieve the desired sonic boom reduction, a main fairing 28 was added to the fuselage and auxiliary fairings 30 and 32 were added to the underside of the nacelles. The design of the main fairing includes three major portions: the nose section 34, the center under fuselage section 36, and the aft close-out section 38.

FIGS. 1 through 7 disclose the salient and prominent features of this invention. These figures show the full nose section, the under fuselage fairing, and the auxiliary fairings under the inlet nacelles. Also depicted is how the area forward of the inlets are not compromised by the new structure. The bottom view (FIG. 4) clearly shows the three bodies and the narrowing in the aft section 38 to clear the Main Landing Gear (MLG) doors. The aft section taper is located such that the taper produces a reduction in pressure that offsets the increase in pressure caused by the nearby inlet.

The main fairing includes a long, slender (from the plan view) and deep (from the side view) forebody, tapering sharply under the fuselage and terminating with a sharp trailing edge.

An aircraft designed in accordance with this invention has been built and flown to demonstrate a reduction in the sonic boom when measured on the ground. The aircraft was an F-5E aircraft, which was heavily modified with a new nose, changes to the underside of the fuselage and additional fairings under each nacelle. FIG. 8 is a left side view of the modified F-5E aircraft 40. Item 42 represents the preexisting F-5E aircraft profile. Item 44 represents the modified nose structure. The modified nose structure, a main fairing 46, and additional fairings 48 were added to the F-5E to construct an aircraft in accordance with this invention.

The fuselage changes included replacing the nose of the aircraft forward of the nose landing gear forward bulkhead and adding new structure and skin to about 75% of the length of the aircraft. The changes affected the stability, handling characteristics and performance of the aircraft. This was the first time that sonic boom shaping has been demonstrated in flight.

The main fairing was designed to create the desired volume distribution to provide the requisite pressure distribution. An intermediate arbitrary distance of two aircraft lengths was chosen as a measure of merit for the shaping exercise. The design approach was to a) determine the volume distribution required, b) render this distribution into a physical shape, and c) test the resultant shape for conformance with the desired pressure distribution. This iterative cycle was repeated many times until a near-optimal shape was derived.

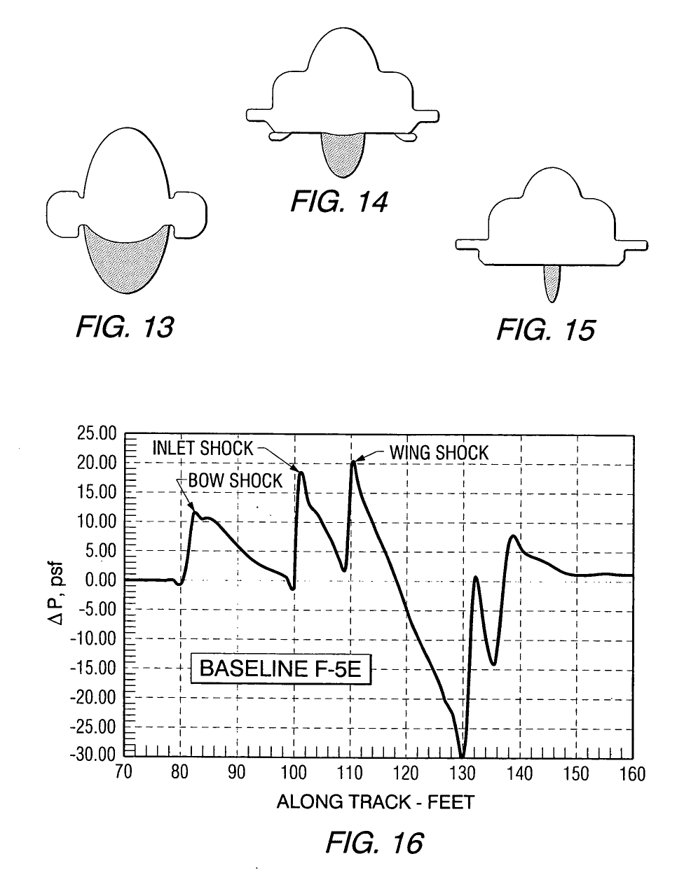

FIGS. 9 through 15 are cross-sections of the aircraft of FIG. 8 taken along lines 9-9 through 15-15. In FIGS. 9 through 15, the shaded portions represent cross-sectional areas of structures used to modify the baseline aircraft. The cross-sections illustrate, in 2-Dimensions, the changes that have been made to the aircraft in 3-Dimensions. The changes to the individual cross-sections modify the overall volume distribution which in turn modifies the pressures all around the aircraft. The pressure distribution below the aircraft is what propagates to the ground as a sonic boom.

This invention provides an aircraft having an airframe shape that produces desired pressure gradients onto the far field to effect a reduction in the magnitude of the sonic boom. This has been accomplished by using a volume distribution consistent with the Seebass/George (S/G) theory. Seebass and George proposed a means to minimize sonic booms by controlling various physical parameters of an aircraft (reference: R. Seebass and A. R. George, The Journal of the Acoustical Society of America, Vol. 51, No. 2, (Part 3), February 1972). These physical parameters relate to aircraft shapes, which create pressure signatures near the aircraft that theoretically produce minimized sonic booms on the ground. It is not possible to apply the full S/G theory to existing aircraft because real aircraft do not conform to all of the assumptions of the theory. To produce the aircraft of this invention, the S/G pressure signature near the aircraft was assumed, and a fairing was designed to produce the required pressure signature below the aircraft.

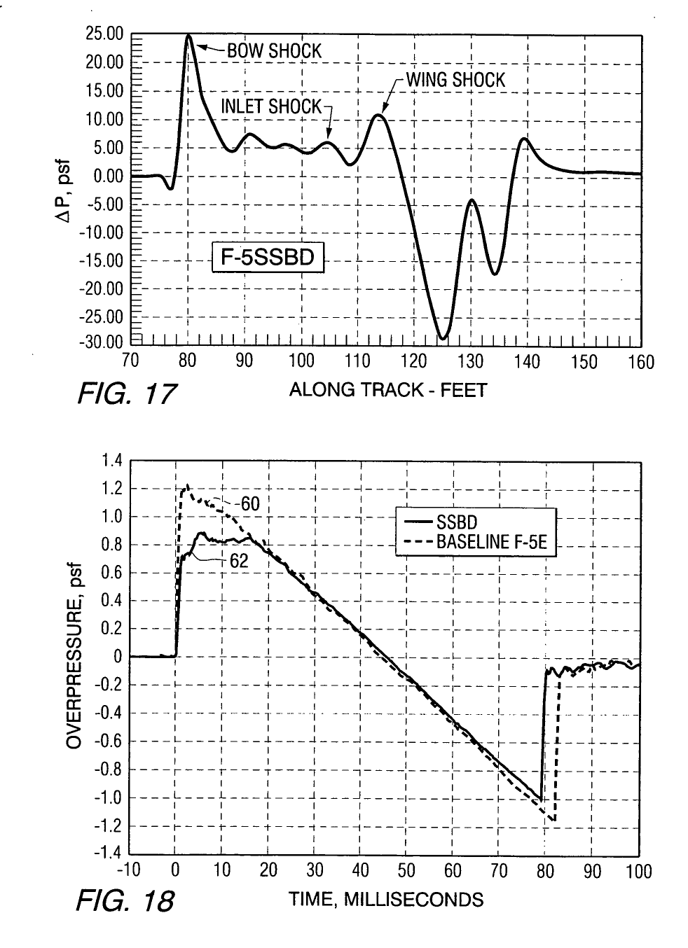

To demonstrate the reduction in sonic boom achieved by an aircraft constructed in accordance with this invention, a sonic boom produced by an unmodified F-5E aircraft can be compared to a sonic boom produced by an F-5E aircraft modified in accordance with this invention. FIG. 16 shows a baseline near field signature of an unmodified F-5E aircraft. FIG. 17 shows the near field signature of an aircraft constructed in accordance with the invention. FIG. 18 shows the measured sonic boom at ground level for a baseline unmodified F-5E (curve 60) and for an aircraft constructed in accordance with the invention (curve 62). The comparison of these curves shows a clear reduction in the sonic boom achieved by the present invention.

An aircraft constructed in accordance with this invention has an airframe shaped to minimize the number of shock and expansion waves propagated below the aircraft forward of the leading edge of the wing by compensating for each shock with a region of reduced local pressure and by compensating for each area of expansion with an area of increased local pressure. This precludes the coalescence of these waves that result in the bow shock in the far field and results in a “flat-top” signature with reduced amplitude in the left hand section of the sonic boom N-wave.

Some of the key design constraints relating to the modification of the F-5E aircraft included: a) do not exceed the length of the F-5F aircraft, b) do not to make the aircraft's forebody wider than the existing aircraft, and c) do not to interfere with the main landing gear doors.

It was quickly determined that a simple ‘glove’ fairing attached to the outer mold line (OML) of the aircraft would be inadequate to achieve the desired reduction in sonic boom. Therefore, the aircraft structure forward of the nose landing gear (NLG) bay was removed and a new nose section was constructed. Additionally, auxiliary fairings were incorporated into the design. The auxiliary fairings are not a requirement for general boom suppression design, but were incorporated to help minimize the size of the fairing.

The forward section of the main fairing is somewhat blunt in the nose to build up area quickly and smoothly back to the maximum cross-section. This nose produced a nose shock that is stronger than the nose shock of the unmodified aircraft, but is not strong enough to adversely affect the maximum speed of the modified aircraft. The majority of the work is done by the main (or center) fairing, which creates shock and expansion zones to neutralize the expansion and shocks, respectively, generated by the baseline F-5E airframe. The aft structure provides the length required to close out the remaining cross-sectional area without creating an unacceptable drag penalty. The auxiliary fairings were located under the inlet nacelles as a means of reducing the volume of the main fairing as it transitioned into the aft closeout section. This was needed to ensure the fairing would be narrow enough to fit between the main landing gear (MLG) doors. The auxiliary fairings produced the desired pressure distribution below the aircraft and met the geometric constraints of the existing aircraft with less drag than could be achieved with other designs. The auxiliary fairings are an example of the difficultly in achieving a pressure distribution that conformed to the Seebass/George theory on a real aircraft. The auxiliary fairings can be located elsewhere, as long as they produced the same pressure distribution below the aircraft.

Seebass/George never applied their theory to a real or existing aircraft so their applications were all theoretical. The aircraft of this invention modify the sonic boom reaching the ground in the manner advanced by Seebass and George, thereby proving the theory in a real atmosphere and establishing a foundation on which supersonic aircraft with significantly quieter sonic booms could be designed.

The modifications to the F-5E were designed to reduce the magnitude of the initial pressure rise of the sonic boom and elongate the duration of the increased pressure creating a “flat top” sonic boom signature. Demonstrating the shaping of the initial part of the sonic boom signature proves that it is possible to manipulate the sonic boom with the shape of the aircraft, enabling the design of an aircraft with a much quieter sonic boom.

This invention has shown how aircraft modified to match a volume distribution can produce a desired pressure distribution for the reduction in the intensity of the sonic boom. The preferred embodiment uses a three-body fairing design. The auxiliary fairings were employed to remove cross-section from the main fairing in order to make it fit between the main landing gear wheel wells.

While the invention has been described in terms of a particular embodiment, it will be apparent to those skilled in the art that various changes can be made to the disclosed embodiment without departing from the scope of the invention as set forth in the following claims.

1. A supersonic aircraft comprising:
a fuselage;
a main fairing positioned along a bottom surface of the fuselage;
wings extending from the fuselage; and
engine nacelles;
wherein the aircraft has contours shaped to create shock and expansion zones to compensate for expansion zones and shocks produced by the wings and engine nacelles when the aircraft travels at supersonic speeds; and
wherein the main fairing includes a nose section, a center section, and an aft section tapered to a sharp point.

2. (canceled)

3. The aircraft of claim 1, wherein the nacelles are positioned adjacent to the fuselage and integral with the wings, and the aircraft further includes:
auxiliary fairings positioned along the bottom surfaces of the nacelles.

4. The aircraft of claim 3, wherein the aft section is linearly tapered and positioned between the auxiliary fairings.

5. The aircraft of claim 1, wherein the center section is positioned forward of a main landing gear of the aircraft.

6. The aircraft of claim 1, wherein the aft section is positioned between the engine nacelles.

7. The aircraft of claim 1, wherein the nose section has a bunt shape.

8. The aircraft of claim 1, wherein the main fairing is shaped to minimize the occurrence of shock and expansion waves created forward of a main landing gear of the aircraft.

9. The aircraft of claim 1, wherein the main fairing extends along about 75% of the length of the aircraft.

10. The aircraft of claim 1, wherein the aircraft volume distribution is structured and arranged to minimize a sonic boom produced by the aircraft.

11. The aircraft of claim 1, wherein the aircraft is shaped to minimize a number of shock and expansion waves propagated below the aircraft forward of the leading edges of the wings.
